(19) United States
(12) Patent Application Publication
(10) Pub. No.: US 2024/0289045 A1
(43) Pub. Date: Aug. 29, 2024

(54) STORAGE SYSTEM AND COMMUNICATION PATH CONTROL METHOD

(71) Applicant: Hitachi, Ltd., Tokyo (JP)

(72) Inventors: Takahiro YAMAMOTO, Tokyo (JP); Misato YOSHIDA, Tokyo (JP); Yoshinori OHIRA, Tokyo (JP)

(73) Assignee: Hitachi, Ltd., Tokyo (JP)

(21) Appl. No.: 18/459,645

(22) Filed: Sep. 1, 2023

(30) Foreign Application Priority Data
Feb. 28, 2023 (JP) 2023-029573

(51) Int. Cl. G06F 3/06

(52) U.S. Cl. CPC G06F 3/065; G06F 3/0604; G06F 3/0673

(57) ABSTRACT

In a storage system, when a communication path for remote copying from a primary volume to a secondary volume is set, a storage node in a primary site makes an inquiry to a discovery node in a secondary site about node information on a node having a secondary volume paired with a primary volume. Based on the node information acquired from the discovery node, a primary volume owner node sets a communication path between the primary volume owner node and a secondary volume owner node, the communication path being used for remote copying volume data from the primary volume to the secondary volume.

### BACKGROUND OF THE INVENTION

### 1. Field of Invention

The present invention relates to a storage system and a communication path control method, and is applied preferably to a storage system and a communication path control method for creating a remote copy pair between a primary site and a secondary site.

### 2. Description of the Related Art

A storage system including a plurality of storage nodes has been known for years. For example, given software is executed in each storage node (hereinafter, “node”) to provide the storage system.

A remote copy function is known as a technique by which, to continue business even when an accident occurs, a storage system is replicated between a plurality of data centers geographically separated from each other. In a storage system including a plurality of nodes and equipped with a remote copy function, a site that processes a business application in a normal situation is referred to as a primary site, and a site that operates in place of the primary site when the storage system stops due to a failure of the entire site on the primary site side is called the secondary site.

For example, US 2018/0032254 A1 discloses a technique according to which, in a configuration in which the secondary site is composed of a plurality of storage devices, when a remote copy pair is made between a primary site and a secondary site composed of a plurality of storage devices, a storage device is selected from the secondary site in such a way as to meet performance and capacity requirements for the primary site and the pair is built using the selected storage device.

### SUMMARY OF THE INVENTION

A volume of the storage system has ownership for processing an I/O request from a host or a different storage system running a different site. The ownership of a volume is given to a specific node in each site (each of the primary site and the secondary site), and an I/O request to any volume is processed by a node to which the ownership is given. In other words, when a certain node receives an I/O request to a volume of which the ownership is not possessed by the node, the node transfers the I/O request to a node having the ownership, and this node having ownership processes the I/O request.

In the storage system, the primary site and the secondary site build remote copy pairs in units of one or more volumes. Volumes in the primary site are referred to as primary volumes (PVOL), and volumes in the secondary site are referred to as secondary volumes (SVOL). When a remote copy pair is created, a communication path is set for transmitting/receiving I/O requests and various commands between the primary site and the secondary site. This communication path is set for communication from a node in the primary site to a node in the secondary site.

In setting the communication path, it is preferable, from the viewpoint of processing performance, that the communication path be set between a node having the ownership of a PVOL in the primary site and a node having the ownership of a SVOL in the secondary site paired with the primary site. This is to avoid a problem that, when the communication path is set with a node not having the ownership (non-ownership node), a remote copy process is executed such that the non-ownership node having received a request transfers the request to a node having the ownership to let it process the request, and such a remote copy process exerts negative effects, such as increasing CPU overhead, network bandwidth consumption, and a longer delay time. However, according to the conventional technique disclosed in US 2018/0032254 A1, a remote copy pair between different sites is built automatically, which poses a problem that the above-described preferable communication path setting cannot be done.

In another case, when creating a remote copy pair, an operator may check information on the primary site and the secondary site and set a communication path between a node having the ownership of the PVOL (PVOL owner node) and a node having the ownership of the SVOL (SVOL owner node). This case, however, makes operation procedures cumbersome and increases an introduction costs and an operation cost, which is a problem.

The present invention has been conceived in view of the above problems, and it is therefore an object of the present invention to provide a storage system and a communication path control method that when creating a remote copy pair between a primary site and a secondary site of the storage system, reduce an operation cost of the storage system and prevent a negative effect on performance at execution of a remote copy process.

In order to solve the above problems, a storage system according to the present invention comprises a primary site and a secondary site each of which includes a plurality of storage nodes and one or more drives, the storage nodes each having a processor package including a processor and a memory. Storage nodes making up the primary site include a primary volume owner node having a primary volume, and storage nodes making up the secondary site include a secondary volume owner node having a secondary volume paired with the primary volume, and a discovery node that as a replay to an inquiry, sends node information on a node having a volume in the secondary site. When a communication path for remote copying from the primary volume to the secondary volume is set, a storage node of the primary site makes an inquiry to a discovery node of the secondary site about node information on a node having the secondary volume paired with the primary volume. As a replay to the received inquiry, the discovery node sends the information on the node having the secondary volume. Based on the node information acquired from the discovery node, the primary volume owner node sets a communication path between the primary volume owner node and the secondary volume owner node, the communication path being used for remote copying volume data from the primary volume to the secondary volume.

In order to solve the above problems, a communication path control method according to the present invention is carried out by a storage system including a primary site and a secondary site each of which includes a plurality of storage nodes and one or more drives, the storage nodes each having a processor package including a processor and a memory. According to the communication path control method, storage nodes making up the primary site include a primary volume owner node having a primary volume, and storage nodes making up the secondary site include a secondary volume owner node having a secondary volume paired with the primary volume, and a discovery node that as a replay to an inquiry, sends node information on a node having a volume in the secondary site. When a communication path for remote copying from the primary volume to the secondary volume is set, a storage node in the primary site makes an inquiry to a discovery node in the secondary site about node information on a node having the secondary volume paired with the primary volume. As a replay to the received inquiry, the discovery node sends the information on the node having the secondary volume. Based on the node information acquired from the discovery node, the primary volume owner node sets a communication path between the primary volume owner node and the secondary volume owner node, the communication path being used for remote copying volume data from the primary volume to the secondary volume.

According to the present invention, when a remote copy pair is created between the primary site and the secondary site of the storage system, an operation cost of the storage system can be reduced and a negative effect on performance at execution of a remote copy process is prevented.

### BRIEF DESCRIPTION OF THE DRAWINGS

FIG. 1 is an image figure of an overview of a storage system 101 according to an embodiment of the present invention;

FIG. 2 depicts an example of a physical configuration of the storage system 101;

FIG. 3 is an image figure of an overview of a remote copy configuration in the storage system 101;

FIG. 4 is an image figure of an overview of I/O request processing in the storage system 101;

FIG. 5 is an image figure of an overview of a process of recovering from a node failure in the storage system 101;

FIG. 6 depicts an example of information stored in a memory 212;

FIG. 7 depicts an example of a system configuration management table 611;

FIG. 8 depicts an example of a pair configuration management table 612;

FIG. 9 is a sequence diagram showing an example of a procedure for a path creating process;

FIG. 10 is a sequence diagram showing an example of a procedure for a write process including a first node failure recovery process;

FIG. 11 is a sequence diagram showing an example of a procedure for a write process including a second node failure recovery process;

FIG. 12 is a sequence diagram showing an example of a procedure for a remote copy process; and

FIG. 13 is a sequence diagram showing an example of a procedure for a path changing process.

### DESCRIPTION OF THE PREFERRED EMBODIMENTS

An embodiment of the present invention will hereinafter be described with reference to drawings.

In the following description, an “interface device” refers to one or more communication interface devices. One or more communication interface devices may be one or more communication interface devices of the same type (e.g., one or more network interface cards (NIC)), or two or more communication interface devices of different types (e.g., a network interface card and a host bus adapter (HBA)).

In the following description, a “memory” refers to one or more memory devices, which is an example of one or more storage devices, and typically refers to a main storage device. At least one memory device making up a memory may be a volatile memory device or a nonvolatile memory device.

In the following description, a “permanent storage device” refers to one or more permanent storage devices, which is an example of one or more storage devices. A permanent storage device may typically be a nonvolatile storage device (e.g.,, an auxiliary storage device), and, specifically may be a hard disk drive (HDD), a solid state drive (SSD), or a nonvolatile memory express (NVMe) drive.

In the following description, a “processor” refers to one or more processor devices. At least one processor device may typically be a microprocessor device, such as a central processing unit (CPU), and may also be a processor device of a different type, such as a graphics processing unit (GPU). At least one processor device may be a single-core processor or multi-core processor. At least one processor device may be a processor core. At least one processor device may be a processor device defined in a broader sense, such as a hardware circuit that executes a part or the whole of a process (e.g., a field-programmable gate array (FPGA)), a complex programmable logic device (CPLD), or an application specific integrated circuit (ASIC).

In the following description, information from which output information is obtained in response to input information may be explained as an “xxx table”. Such information, however, may be data of any structure (e.g., it may be structured data or unstructured data.), or may be a neural network that outputs data in response to incoming data or a learning model represented by a genetic algorithm, a random forest tree, etc. The “xxx table”, therefore, can be referred to as “xxx information”. In the following description, a configuration of each table is shown exemplarily. One table may be divided into two or more tables, or the whole or a part of two or more tables may be integrated into one table.

In the following description, a process is described, using a “program” as the subject of the process in some cases. However, given the fact that a program executed by a processor performs a given process, using a storage device and/or an interface device on a necessary basis, the subject of the process may be defined as the processor (or a device having the processor, such as a controller). A program may be acquired from a program source and installed in such a device as a computer. The program source may be, for example, a program distribution server or a computer-readable recording medium (e.g., a non-transitory recording medium). In the following description, two or more programs may be implemented as one program or one program may be implemented as two or more programs.

In the following description, when elements of the same type are described without being distinguished from each other, common parts of their reference numerals including branch numbers (that is, common parts left by ridding the reference numerals of the branch numbers) may be used, and when elements of the same type are distinguished from each other and are described separately, their reference numerals including branch numbers may be used. For example, in a case where nodes are described without being distinguished from each other, the nodes may be collectively referred to as “node 210”. In a case where the nodes are distinguished from each other and are described separately, on the other hand, individual nodes may be referred to as “node 210a”, “node 210b”, and the like. In addition, in the case of distinguishing elements of the same type from each other and describing them separately, a different reference method may be adopted, which uses an element ID (e.g., an identification number). Specifically, for example, the above “node 210a” and “node 210b” may be referred to as a “node 1” and a “node 2”, respectively. Furthermore, by adding “v” to the name of an element included in a node v (v denotes an integer equal to or larger than 0), the element is belonging to (corresponding to) the node v can be distinctively indicated, that is, which node the element belongs to (which node the element corresponds to) can be distinctively indicated by this notation.

### (1) Configuration and Overview of System

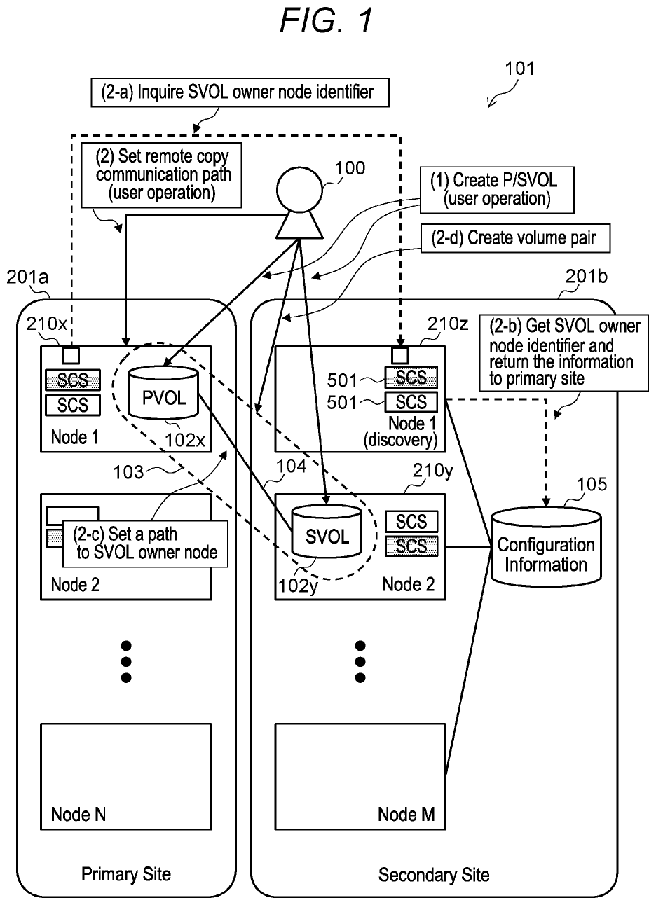

FIG. 1 is an image figure of an overview of a storage system 101 according to an embodiment of the present invention. FIG. 1 shows an overview of the storage system 101 in which a remote copy pair is set between a volume 102x in a site 201a and a volume 102y in a site 201b. Hereinafter, a case where a remote copy pair 103 is set in the system including the site 201a defined as a primary site, its volume 102x as a PVOL, the site 201b as a secondary site, and its volume 102y as an SVOL will be described with reference to FIG. 1.

The storage system 101 includes the primary site 201a and the secondary site 201b, each of which has an independent storage cluster built therein, the storage cluster including a plurality of nodes 210 and a shared database 105 storing configuration information shared among nodes in the site. The number of nodes making up the storage cluster of the primary site 201a and the same making up the storage cluster of the secondary site 201b may be different from each other. For convenience in illustration, FIG. 1 shows the shared database 105 in the secondary site 201b without showing the shared database 105 in the primary site 201a. Following steps indicated in FIG. 1, a user 100 builds a volume pair that is made as a remote copy pair between the primary site 201a and the secondary site 201b.

Step (1) shown in FIG. 1 will be described. Step (1) will be described as a process executed by the user 100. Step (1), however, may be executed by a program stored in the storage system 101.

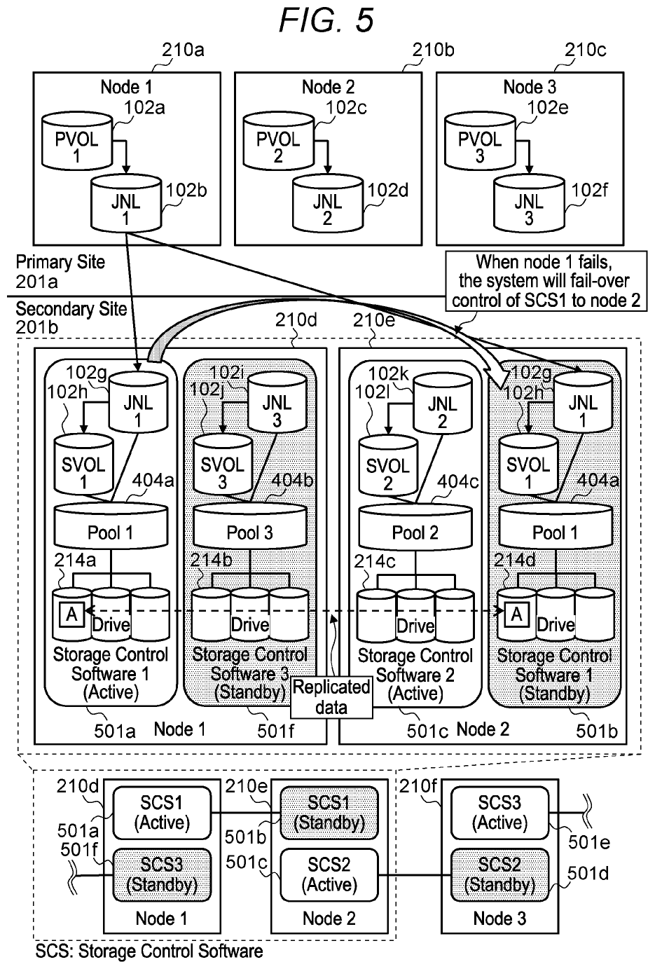

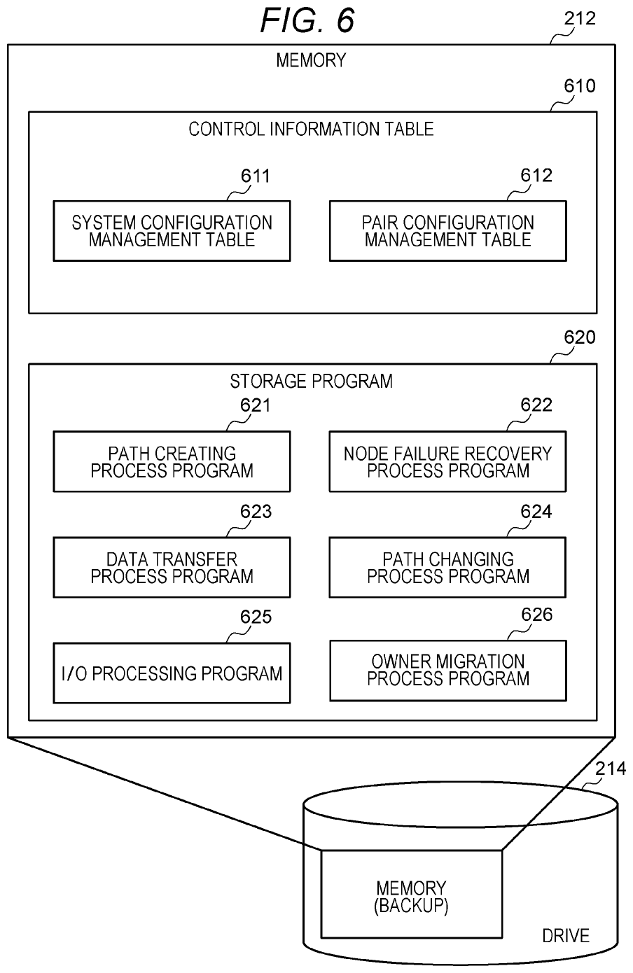

At step (1), the user 100 instructs the primary site 201a to create the volume 102x serving as the PVOL, and instructs the secondary site 201b to create the volume 102y serving as the SVOL. An instruction to create a volume may be issued to any node in the site. The storage system 101 (more specifically, active SCS 501 of a node 210 having received an instruction to create the volume 102y or active SCS 501 of a different node 210 having received the instruction transferred thereto) creates the volume 102 in a preferable node 210 while taking account of the capacity usage and the processing load status of each node in the site. For example, the storage system 101 creates the volume 102 in a node with a low capacity usage and a small processing load. In FIG. 1, the storage system 101 creates the PVOL 102x in a node 210x in the primary site 201a and creates the SVOL 102y in a node 210y in the secondary site 201b. The SCS 501 is storage control software (SCS) that causes a processor to execute given programs, which include a storage program 620 shown in FIG. 6 that will be described later. In each node 210, a pair of active SCS 501 and standby SCS 501 are present. The SCS 501 will be described in detail later in a description with reference to FIG. 5.

Step (2) shown in FIG. 1 will be described.

At step (2), the user 100 instructs the primary site 201a to set a communication path for remote copying. At this time, the user 100 specifies identifiers (PVOL ID, SVOL ID) for the PVOL and the SVOL, which make a remote copy pair, and the communication destination address (e.g., an IP address and a port number) of a discovery node (a node 210z in FIG. 1) in the secondary site 201b. The discovery node has a function of sending node information on a node 210 having a volume in the site to which the discovery node belongs, in response to an incoming inquiry. For example, when the primary site 201a makes an inquiry to the discovery node 201z of the secondary site 201b about node information, the discovery node 201z sends node information on a node (SVOL owner node) having ownership of the SVOL, in response to the inquiry. The SVOL owner node may serve also as the discovery node or a plurality of nodes may function as the discovery nodes. When the node 210x in the primary site 201a receives the user instruction, the node 210x makes an inquiry to the discovery node (node 210z) in the secondary site 201b, the discovery node being specified by the user 100, about information on the node having the ownership (control right) of the SVOL (step (2-a)).

In the storage system 101, the primary site 201a may too include a discovery node having a function of sending node information on a node (PVOL owner node) having ownership of the PVOL in the site (the primary site) to which the discovery node belongs, in response to an incoming inquiry in the same manner as the discovery node of the secondary site 201b sends node information on the PVOL owner node. In such a configuration, one of both sites is able to acquire node information on a node having ownership of a volume paired with a volume belong to the one site, from a discovery node belong to the other site. Both sites are thus each able to acquire the node information by making an inquiry to any node belonging to the other site.

Subsequently, the node 210z in the secondary site 201b (more specifically, the SCS 501 of the node 210z), the node 210z having received the inquiry, acquires the node information on the node having the ownership of the SVOL, from the shared database 105 storing in-site configuration information, and sends the node information back to the node 210x in the primary site 201a (step (2-b)).

Subsequently, the node 210x having the ownership of the PVOL in the primary site 201a sets a communication path 104 between the node 210x and the node 210y having the ownership of the SVOL in the secondary site 201b, the node 210y being the node on which the node information having been acquired at step (2-b).

Finally, the storage clusters of the primary site 201a and the secondary site 201b register the PVOL 102x and the SVOL 102y being the remote copy pair 103 with the shared databases 105 in their sites, respectively, thus completing setting of the remote copy pair of the PVOL and the SVOL (step (2-d)).

The above step (2) and processes involved therein may be executed according to an instruction given by the user 100 to the secondary site 201b to set the communication path for remote copying, in which case the secondary site 201b executes the steps and processes on the primary site 201a. In this case, a node of the secondary site 201b makes an inquiry to a node of the primary site 201a about node information on a node having the ownership of the PVOL, and the secondary site 201b sets a communication path between a node having the ownership of the PVOL and a node having the ownership of the SVOL.

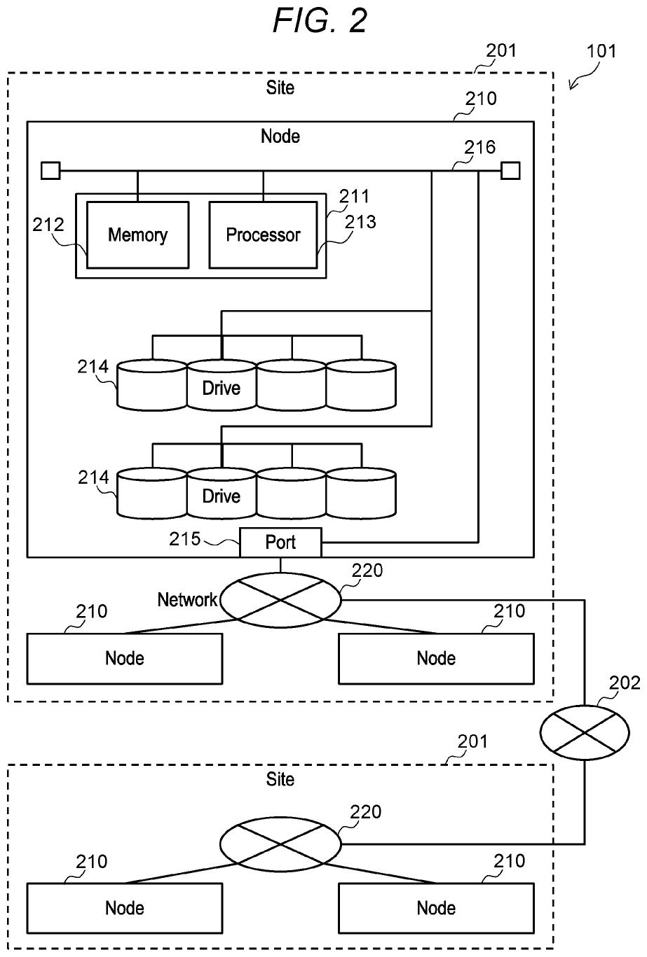

FIG. 2 depicts an example of a physical configuration of the storage system 101. As shown in FIG. 2, the storage system 101 may include one or more sites 201.

The sites 201 are interconnected via a network 202 to be capable of communicating with each other. The network 202 is, for example, a wide area network (WAN), but is not limited to the WAN. Each site 201, which is a data center or the like, includes one or more nodes 210.

The node 210 may have a configuration of a general server computer. The node 210 includes, for example, one or more processor packages 213 each including a processor 211 and a memory 212, one or more drives 214, and one or more ports 215. These constituent elements are interconnected via an internal bus 216.

The processor 211, which is, for example, a central processing unit (CPU), carries out various processes,

The memory 212 stores control information necessary for implementing functions of the node 210 and stores data as well. The memory 212 further stores, for example, a program executed by the processor 211. The memory 212 may be a volatile dynamic random access memory (DRAM), a nonvolatile storage class memory (SCM), or a storage device different from these memories.

The drive 214 stores various data, programs, and the like. The drive 214, which is an example of a storage device, may be a hard disk drive (HDD) or a solid state drive (SSD) conforming to a serial attached SCSI (SAS) protocol or a serial advanced technology attachment (SATA) protocol, an SSD or SCM conforming to a non-volatile memory express (NVMe) protocol, or a drive box carrying a plurality of HDDs or SSDs.

The port 215 is connected to a network 220, thus connecting a node to which the port 215 belongs to a different node 210 in the site 201, via the network 220. The network 220 is, for example, a local area network (LAN), but is not limited to the LAN.

The physical configuration of the storage system 101 is not limited to the physical configuration described above. For example, the networks 202 and 220 may be made redundant in configuration. In addition, for example, the network 220 may be separated into a management network and a storage network, may run in conformity to a connection protocol for an Ethernet (registered trademark), Infiniband, or radio communication network, and has a connection topology not limited to a connection topology shown in FIG. 2. Furthermore, for example, the drive 214 may be configured to be independent of the node 210.

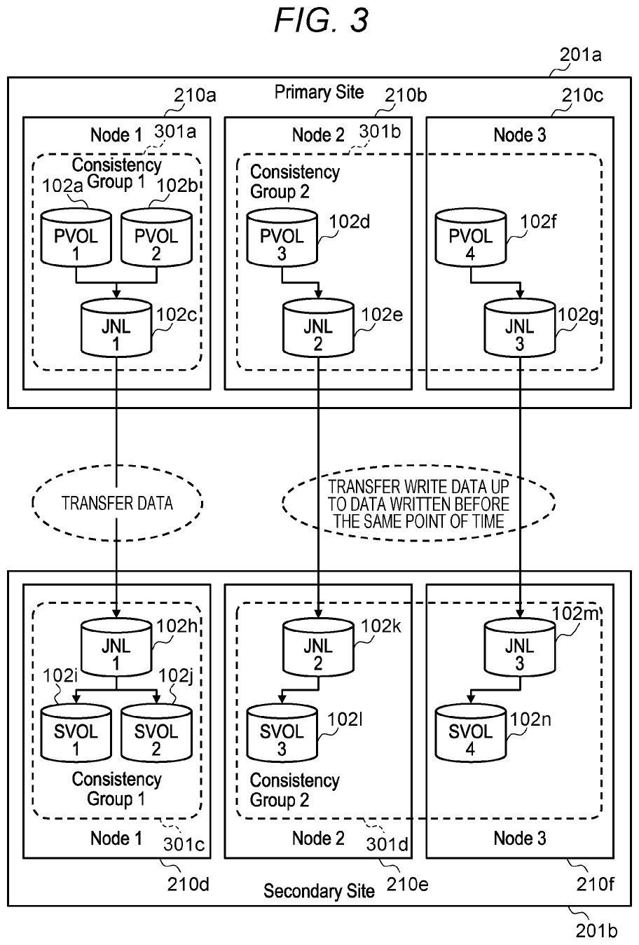

FIG. 3 is an image figure of an overview of a remote copy configuration in the storage system 101. Specifically, FIG. 3 shows an overview of a situation where remote copy pairs are built between a plurality of volumes of the primary site 201a and the same of the secondary site 201b in the storage system 101, respectively.

In the case of FIG. 3, two consistency groups 301a and 301b are built between the primary site 201a and the secondary site 201b. Each consistency group is composed of a plurality volumes making up remote copy pairs, and a plurality of volumes in the consistency group in the primary site are copied to the secondary site as the consistency between the volumes is maintained. Specifically, updating difference data up to the same point of time of the volumes 102 in the consistency group 301 is copied to the secondary site 201b. Control of the consistency group (consistency control) is assumed by a journal volume (JNL). Updating difference data of a plurality of PVOLs, together with metadata indicating a time at which the updating difference data has been written, is stored in the journal volume. When transferring data of the PVOL to the secondary site 201b, the storage cluster of the primary site 201a transfers updating difference data up to the same point of time among the updating difference data of the PVOLs written to the journal volume, to the secondary site 201b. As a result, the data of the PVOL can be copied to the SVOL of the secondary site 201b as the consistency in updating time between the PVOLs is maintained.

Specifically, in the configuration shown in FIG. 3, the consistency group 301a copies data to volumes 102i and 102j (i.e., SVOLs 102i and 102j of a consistency group 301c) in a node 210d of the secondary site 201b while maintaining the consistency between the volumes 102a and 102b in the node 210a of the primary site 201a. The consistency group 301b copies data to a volume 102l in a node 210e of the secondary site 201b and to a volume 102n in a node 210f of the secondary site 201b (i.e., SVOLs 102l and 102n of a consistency group 301d) while maintaining the consistency between a volume 102d in a node 210b of the primary site 201a and a volume 102f in a node 210c of the primary site 201a.

It is understood from the above specific configuration that the consistency group 301 may be composed of volumes in a specific node in a site or of volumes in a plurality of nodes in the site.

Besides, in the storage system 101, a remote copy pair may be built by directly associating the PVOL with the SVOL without consistency control by the journal volume, which case is not illustrated. In this case, updating difference data to the PVOL is directly transferred to a node having the SVOL without being written to the journal volume, and is therefore written directly to the SVOL. In such a case where the PVOL and the SVOL are directly paired, the journal volume is not involved in the process of transferring updating difference data from the PVOL to the SVOL and therefore updating difference data of the PVOL can be quickly reflected in the SVOL. This method is therefore useful in a case where remote copying is carried out in synchronization with an I/O process by the host. In the case where the PVOL and the SVOL are directly paired, however, consistency control, i.e., reflecting updating difference data up to the same point of time in the SVOL, cannot be carried out because the journal volume is not involved in the paring process.

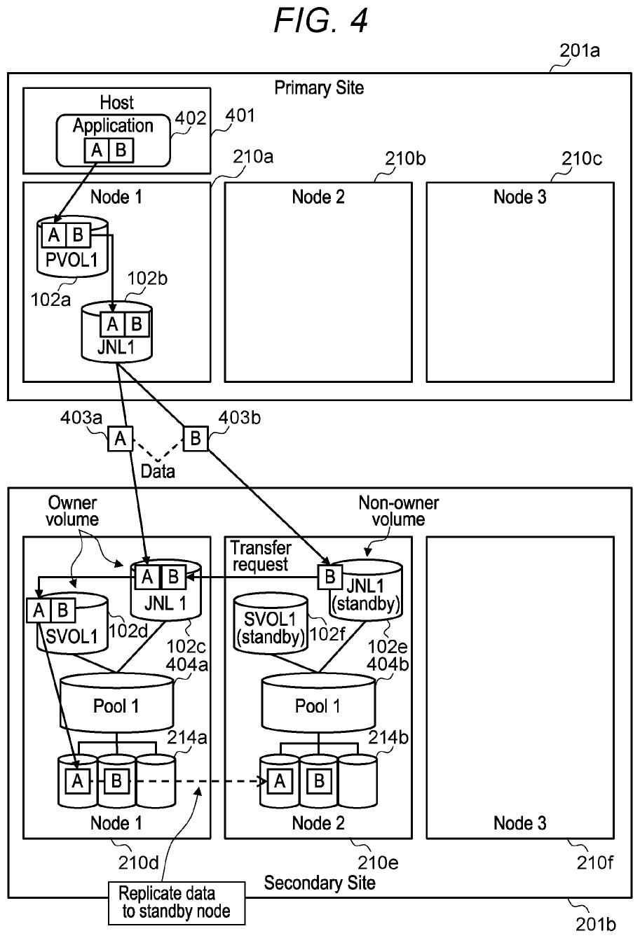

FIG. 4 is an image figure of an overview of I/O request processing in the storage system 101. Specifically, FIG. 4 shows an overview of I/O processing in a situation where a remote copy pair is built between the PVOL 102a of the primary site 201a and the SVOL 102d of the secondary site 201b in the storage system 101.

First, an application 402 running on a host 401 issues a write request to the node 210a for writing data 403a (data A) and data 403b (data B) to the PVOL 102a. Having received the write request, the node 210a writes the data A and data B to the PVOL 102a and writes the data A and data B also to a journal volume 102b (JNL1), as updating difference data.

The node 210a then transfers the updating difference data written on the journal volume 102b, to journal volumes 102c and 102e of the secondary site 201b. At this time, when a plurality of communication paths are established between the primary site 201a and the secondary site 201b, any one of the communication paths may be used to transfer the data. Usually, the node 210a of the primary site 201a transfers the updating difference data to the node 210d having the ownership of the SVOL 102d paired with the PVOL 102a. However, when a communication path leading to the node having the ownership develops a failure, the updating difference data may be transferred to the node 210e or the like not having the ownership. For example, when the node 210a of the primary site 201a transfers the updating difference data to the node 210e of the secondary site 201b, the node 210e not having the ownership, the node 210e of the secondary site 201b transfers the received updating difference data to the node 210d having the ownership, and the node 210d writes the transferred updating difference data to the journal volume 102c.

The node 210d then periodically writes the updating difference data written on the journal volume 102c of the secondary site 201b, to the SVOL 102d. Subsequently, the data 403a and 403b (data A and B) written on the SVOL 102d are written to a drive 214a via a storage pool 404a. When the drive 214a is configured as a direct attached storage (DAS) in which a node (server) and a drive are connected on a one-to-one basis, the data is written to a local drive (drive 214a) incorporated in the node 210d. In this manner, the data to be written to the SVOL 102d is written entirely to the drive 214a of the node 210d having the ownership of the SVOL 102d. As a result, when the data is read from the SVOL 102d later, there is no needed to read the data from a different node. The storage system 101 thus eliminates data transfer between different nodes, achieving a faster reading process.

The storage pool 404 (e.g., the storage pool 404a) has storage functions of thin-provisioning, compression, deduplication, etc., and implements a storage function necessary to process data written to the storage pool 404. In addition, to protect the data from a node failure when writing the data to the drive 214a, the storage system 101 writes redundant data of the write data (A and B), to a drive 214b of a different node (e.g., a node 210e that is a standby node). When a data protection policy of replication is adopted in redundant data writing, the storage system 101 writes a replica of the write data, to the drive 214b, as redundant data. When a data protection policy of erasure coding is adopted, on the other hand, the storage system 101 calculates a parity from the write data and writes the calculated parity to the drive 214b, as redundant data.

In FIG. 4, internal configurations of the nodes 210b, 210c, and 210f are not shown. These nodes 210, however, may have PVOLs or SVOLs and process I/O requests from the host 401 in the same manner as the above nodes 210a, 210d, and 210e do.

A flow of the I/O processing shown in FIG. 4 is an example of push-type I/O processing of causing the primary site 201a to deliver data to the secondary site 201b. The storage system 101, however, can also execute pull-type I/O processing of causing the secondary site 201b to read data from the primary site 201a.

FIG. 5 is an image figure of an overview of a process of recovering from a node failure in the storage system 101. Specifically, FIG. 5 shows an overview of a process of recovering from a node failure that has occurred in the secondary site 201b in a situation where a remote copy pair is built between a volume of the primary site 201a and a volume of the secondary site 201b in the storage system 101. The node failure mentioned in this description is a failure that requires a change in path setting.

In the storage system 101 shown in FIG. 5, the storage control software (SCS) 501 for implementing various storage functions of I/O processing, thin-provisioning, compression, deduplication, etc., is operating at each node 210 (210d, 210e, 210f). In each node 210, storage control software 501 of an active type (active), which executes a process in normal mode, and storage control software 501 of a standby type (standby) are in operation. Specifically, in the case of FIG. 5, storage control software (active) 501a and storage control software (standby) 501f operate in the node 210d, storage control software (active) 501b and storage control software (standby) 501c operate in the node 210e, and storage control software (active) 501e and storage control software (standby) 501d operate in the node 210f. A node 210 in which the active storage control software 501 operates is referred to as an active node, and a node 210 in which the standby storage control software 501 operates is referred to as a standby node.

The active storage control software 501 and the standby storage control software 501 are paired. As shown in FIG. 5, SCSs with the same subscripts of 1, 2, or 3 are paired. In normal mode, the storage control software (active) 501a, 501c, and 501e processes an I/O request and implements a storage function. When the active storage control software stops running because of its failure, the paired standby storage control software is promoted to active storage control software and takes over the process.

A process of recovering from a node failure will be described using the specific example shown in FIG. 5.

In the node 210d, the storage control software (active) 501a is running as the storage control software (standby) 501b paired with the storage control software (active) 501a is running in the node 210e. The node 210d included in the secondary site 201b has a SVOL 201h making a remote copy pair with the PVOL 102a of the node 210a in the primary site 201a.

To take over remote copy pair information of the node 210d, the node 210e has a replica of configuration information on the SVOL 102h and the journal volume 102g included in the node 210d. In addition, the node 210e stores redundant data of data written to the drive 214a of the node 210d, in a drive 214d. Furthermore, the node 210e has a communication path established between the node 210e and the node 210a of the primary site 201a.

For example, when the node 210d stops operating because of its failure, the node 210e having detected the failure takes over a process carried out by the storage control software (active) 501a of the node 210d, promotes the storage control software (standby) 501b to active storage control software, and communicates with the node 210a of the primary site 201a, thereby continuing the remote copy process between the PVOL 102a and the SVOL 102h. In other words, when the node 1 (node 210d) of the secondary site 201b stops operating because of its fare, the storage system 101 hands over control by the SCS1 (SCS 501a) of the node 1 to the SCS1 (SCS 501b) of the node 2, the SCS 501b being paired with the SCS 501a, in a failover process. By this failover process, according to the storage system 101, even when a node failure occurs in the secondary site 201b, the secondary site 201b is able to continue the remote copy process of data copying from the primary site 201a.

FIG. 6 depicts an example of information stored in the memory 212. Information shown in FIG. 6 includes information read from the drive 214 to the memory 212. Specifically, various tables included in a control information table 610 and various programs included in a storage program 620 are loaded on the memory 212 during execution of processes in which tables and programs are used, but, as a precaution against a power failure accident, etc., are stored in a nonvolatile storage area, such as the drive 214, when the processes are not executed.

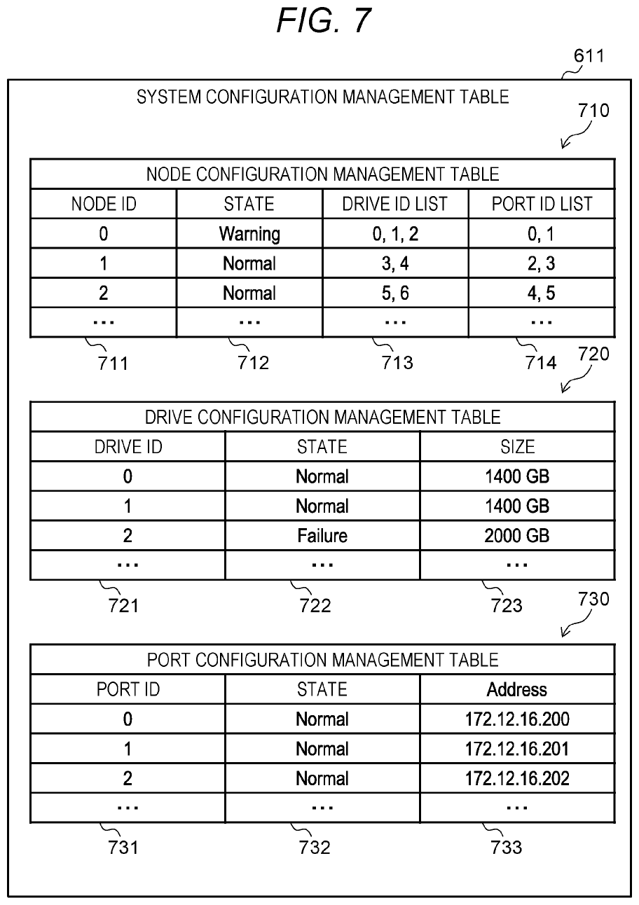

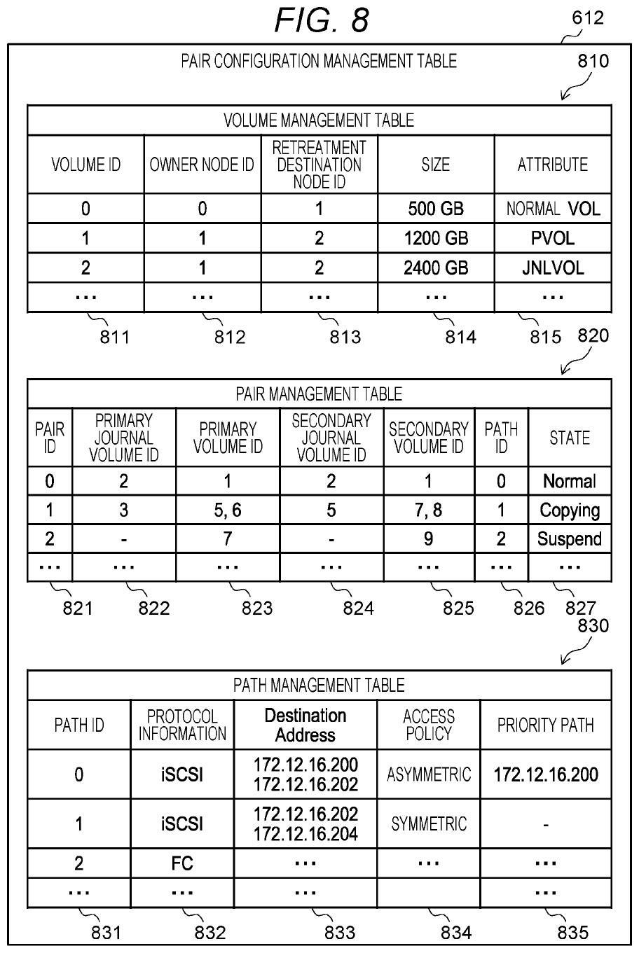

The control information table 610 includes a system configuration management table 611 and a pair configuration management table 612. Details of each of these tables will be described later with reference to FIGS. 7 and 8.

The storage program 620 includes a path creating process program 621, a node failure recovery process program 622, a data transfer process program 623, a path changing process program 624, an I/O processing program 625, and an owner migration process program 626. The programs making up the storage program 620 are an example of programs that are used when various functions (path creating, recovery from a node failure, data transfer, path changing, owner migration) of the node 210 are implemented by software (storage control software 501). Specifically, the processor 211 reads these programs from the drive 214 onto the memory 212 and executes the programs. In the storage system 101 according to this embodiment, various functions of the node 210 may be implemented by hardware, such as a dedicated circuit having the functions corresponding to the above programs, or may be implemented by a combination of software and hardware. Some of the functions of the node 210 may be implemented by a different computer capable of communicating with the node 210.

FIG. 7 depicts an example of the system configuration management table 611. The system configuration management table 611 stores information for managing the configurations of the node 210, the drive 214, and the port 215 in the site 201.

The system configuration management table 611 includes a node configuration management table 710, a drive configuration management table 720, and a port configuration management table 730. The storage system 101 manages, for each site 201, the node configuration management table 710 for information on a plurality of nodes 210 present in each site 201, and each node 210 manages the drive configuration management table 720 and the port configuration management table 730 for information on a plurality of drives 214 in the node 210.

The node configuration management table 710 is provided for each site 201, and stores information indicating configurations related to nodes 210 included in the site 201 (relationships between nodes 210 and drives 214, or the like). More specifically, the node configuration management table 710 stores information that associates node ID 711, state 712, drive ID list 713, and port ID list 714 with each other.

The node ID 711 is identification information for identifying each node 210. The state 712 is state information indicating a state of the node 210 (e.g., NORMAL, WARNING, FAILURE, and the like). The drive ID list 713 is identification information for identifying each drive 214 included in the node 210. The port ID list 714 is identification information for identifying each port 215 included in the node 210.

The drive configuration management table 720 is provided for each node 210, and stores information indicating configurations related to drives 214 included in the node 210. More specifically, the drive configuration management table 720 stores information that associates drive ID 721, state 722, and size 723 with each other.

The drive ID 721 is identification information for identifying each drive 214. The state 722 is state information indicating a state of the drive 214 (e.g., NORMAL, WARNING, FAILURE, and the like). The size 723 is information indicating the capacity of the drive 214 (e.g., TB (terabyte) or GB (gigabyte)).

The port configuration management table 730 is provided for each node 210, and stores information indicating configurations related to ports 215 included in the node 210. More specifically, the port configuration management table 730 stores information that associates port ID 731, state 732, and address 733 with each other.

The port ID 731 is identification information for identifying each port 215. The state 732 is state information indicating a state of the port 215 (e.g., NORMAL, WARNING, FAILURE, and the like). The address 733 is information indicating an address on a network (identification information) that is assigned to the port 215. The address may be assigned in the form of an Internet protocol (IP) address, a world wide name (WWN) address, a media access control (MAC) address, or the like.

FIG. 8 depicts an example of the pair configuration management table 612. The pair configuration management table 612 stores information for managing configurations of the volume 102, the remote copy pair 103, and the communication path 104 for the remote copy pair in the site 201.

The pair configuration management table 612 includes a volume management table 810, a pair management table 820, and a path management table 830. In the storage system 101, each node 210 in the site 201 stores pieces of information provided by the volume management table 810, the pair management table 820, and the path management table 830, in the shared database 105, and therefore these pieces of information can be acquired from any node 210 in the site 201.

The volume management table 810 stores information indicating configurations related to volumes 102. More specifically, the volume management table 810 stores information that associates volume ID 811, owner node ID 812, retreatment destination node ID 813, size 814, and attribute 815 with each other.

The volume ID 811 is identification information for identifying each volume 102. The owner node ID 812 is information indicating a node 210 having ownership of the volume 102. The retreatment destination node ID 813 is information indicating a node 210 that when a different node 210 having ownership of the SVOL fails, takes over a process from the different node 210. The size 814 is information indicating the capacity of the volume 102 (e.g., TB (terabyte) or GB (gigabyte)). The attribute 815 is information indicating the attribute of the volume 102, listing attribute types: normal VOL (volume), PVOL (primary volume), SVOL (secondary volume), JNLVOL (journal volume), and the like.

The pair management table 820 stores information indicating configurations related to remote copy pair 103. More specifically, the pair management table 820 stores information that associates pair ID 821, primary journal volume ID 822, primary volume ID 823, secondary journal volume ID 824, secondary volume ID 825, path ID 826, and state 827 with each other.

The pair ID 821 is identification information for identifying each remote copy pair 103. The primary journal volume ID 822 is an ID for a volume 102 that records journal information on a volume in the primary site 201a that makes up the remote copy pair 103. The primary volume ID 823 is an ID for a volume 102 that is a copy source in the primary site 201a that makes up the remote copy pair 103. The secondary journal volume ID 824 is an ID for a volume 102 that records journal information on a volume in the secondary site 201b that makes up the remote copy pair. The secondary volume ID 825 is an ID for a volume 102 that is a copy destination in the secondary site 201b that makes up the remote copy pair. The path ID 826 is identification information for identifying each communication path 104 for executing the remote copy process, storing detailed information on the communication path 104, the information corresponding to information indicated in the path management table 830. The state 827 is state information indicating a state of the remote copy pair 103 (e.g., NORMAL, COPYING, SUSPEND, and the like).

The path management table 830 stores information indicating configurations related to communication path 104 for the remote copy pair 103. More specifically, the path management table 830 stores information that associates path ID 831, protocol information 832, Destination Address 833, access policy 834, and priority path 835 with each other.

The path ID 831 is identification information for identifying each communication path 104. The protocol information 832 is information indicating a communication protocol for the communication path 104. The communication protocol for the communication path 104 may be Internet small computer system interface (iSCSI), fibre channel (FC), or NVMe over fabrics (NVMe-oF), or may be a unique protocol set up by a vendor. The Destination Address 833 is information indicating the address of a communication destination to communicate with through the communication path 104. The access policy 834 is information indicating a request issuing method according to which, when a plurality of communication destinations are listed in the Destination Address 833, a request is issued to the communication destinations. For example, by a “symmetric” request issuing method, a request is issued to a plurality of paths in a round-robin style, while by an “asymmetric” request issuing method, a priority path is set and a request is issued to the priority path only. The priority path 835 is information indicating a communication destination to which a request is issued in priority when the access policy 834 is “asymmetric”.

### (2) Processes

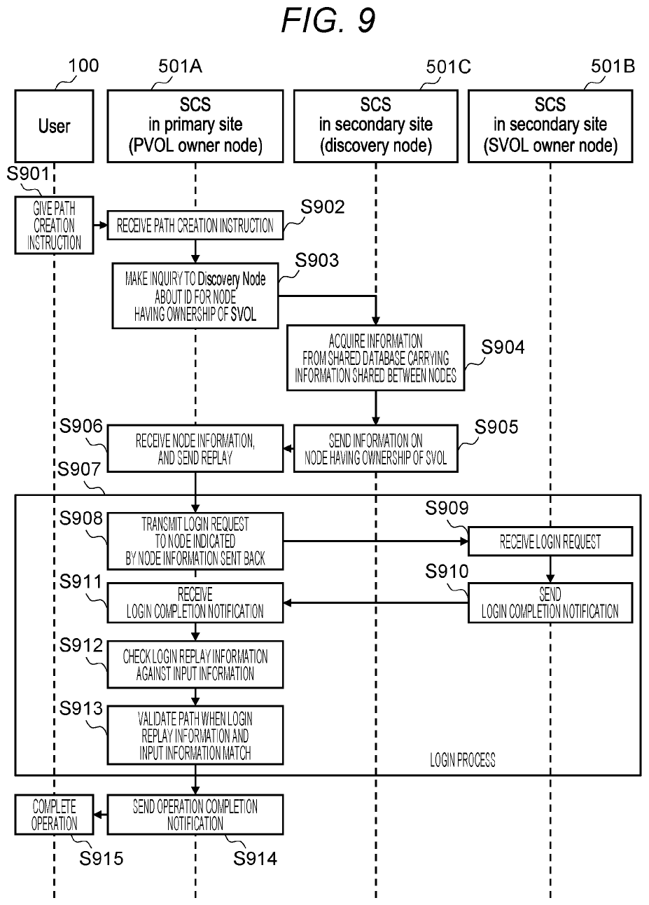

Typical processes executed in the storage system 101 having the above-described configuration will be described with reference to sequence diagrams shown in FIGS. 9 to 13. In description of each sequence diagram, a process described with the storage control software (SCS) 501 being the subject of the description may be considered to be a process executed by any one of storage programs 620 called by the SCS 501 (which is a program having been called at or before execution of the process and will be specified in the course of the description).

### (2-1) Path Creating Process

FIG. 9 is a sequence diagram showing an example of a procedure for a path creating process. The path creating process is a process corresponding to step (2) of FIG. 1. After the user 100 creates the PVOL and the SVOL that make a remote copy pair, as indicated at step (1) of FIG. 1, when the storage system 101 receives an instruction (path creating instruction) from the user 100 to set a communication path between the primary site and the secondary site, the storage control software 501 (501A to 501C) of each node 210 related to the instruction calls the path creating process program 621, which executes the process shown in FIG. 9.

The path creating process (path creating process program 621) shown in FIG. 9 includes a process by the storage control software (SCS) 501A of the PVOL owner node in the primary site, a process by the storage control software (SCS) 501C of the discovery node in the secondary site, and a process by the storage control software (SCS) 501B of the SVOL owner node in the secondary site.

In FIG. 9, the user 100 first gives a path creating instruction including the address of a port to which the discovery node of the secondary site connects, IDs for the PVOL and SVOL making the pair, and a cluster ID for the secondary site (step S901).

Subsequently, when a node having ownership of the PVOL in the primary site (PVOL owner node) receives the path creating instruction from the user, the SCS 501A of the node calls the path creating process program 621 (step S 902).

The SCS 501A then makes an inquiry to the discovery node of the secondary site, the discovery node being specified by the user, about node information on a node having ownership of the SVOL (step S903).

When the discovery node of the secondary site receives the inquiry about the node information made at step S 902, the SCS 501C of the discovery node calls the path creating process program 621, refers to the shared database carrying information shared between the nodes, and acquires information on the node having the ownership of the SVOL (step S904).

The SCS 501C then sends the node information acquired at step S 904 to the node of the primary site that has made the inquiry (step S905). The node information, which is a replay to the inquiry, may include information on a plurality of nodes. Such information includes, for example, information on the node having the ownership of the SVOL and information on a standby node that when the above node develops a failure, takes over a process from the node. The node information further includes information necessary for connection and communication, such as a node ID, the WWN of a connection destination, an IP address, a port number, and a security key.

The node having the ownership of the PVOL in the primary site receives the replay from the discovery node in the secondary site (step S906).

Subsequently, at step S907, connection through the communication path between the node in the primary site and the node in the secondary site is established (login process). The login process at step S907, specifically, includes steps S908 to S913.

At step S908, the SCS 501A issues a login request to the node indicated by the node information acquired at step S906 (that is, the SVOL owner node in the secondary site).

At step S909, the SVOL owner node in the secondary site receives the login request issued at step S908, and the SCS 501B of the SVOL owner node calls the path creating process program 621.

At step S910, the SCS 501B confirms the login request received at step S909, and when finding no problem with parameters of the login request, transmits a login completion notification to the PVOL owner node.

At step S911, the SCS 501A of the PVOL owner node in the primary site receives the login completion notification from the SVOL owner node in the secondary site. The login replay, i.e., login completion notification includes node information on the SVOL owner node in the secondary site. Specifically, the login replay includes the WWN and IP address of a connection destination port, a port number, and the cluster ID for the secondary site.

At step S912, the SCS 501A checks the input information from the user 100 received at step S902 against the login replay information received at step S911 to verify that both information match.

At step S913, when checking the input information from the user 100 against the login replay information at step S912 demonstrates that both information match, the SCS 501A determines that it has successfully logged in to the correct connection destination, thus validating the established communication path as the communication path for remote copying. When checking the input information from the user 100 against the login replay information at step S912 demonstrates that both information do not match, on the other hand, the SCS 501A determines that it has logged in to a wrong connection destination, and therefore logs out therefrom and informs the user 100 of an error in a path creating operation.

As described above, when a redundant path is created in the storage system 101, the login process is executed also on the redundancy destination node including the SVOL paired with the PVOL.

At step S914 following normal completion of the login process at step S907 (steps S908 to S913), the SCS 501A notifies the user 100 of completion of the path creating operation.

Then, at step S915, the user 100 receives the notification of completion of the path creating operation, the notification being sent from the PVOL owner node in the primary site at step S914, and at this point, the path creating process comes to an end.

### (2-2) Node Failure Recovery Process

The process of recovering from a node failure (node failure recovery process), the process having been described with reference to FIG. 5, will be described in details by referring to two procedures for first and second processes. In the node failure recovery process, the storage control software 501 (501A, 501D, 501E) of each node 210 involved in the process calls and executes the node failure recovery process program 622 for each node.

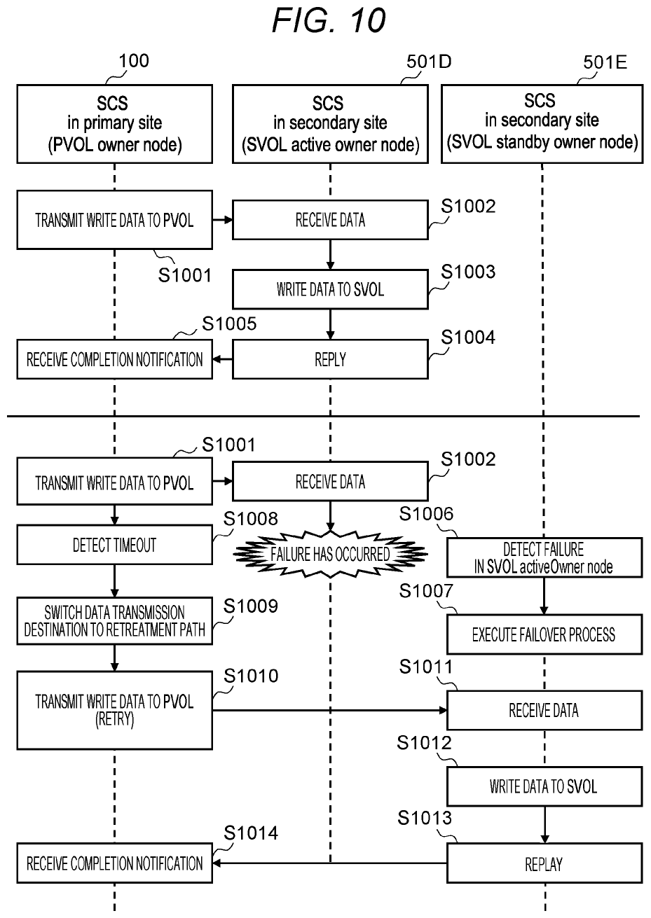

FIG. 10 is a sequence diagram showing an example of a procedure for a write process including a first node failure recovery process. The first node failure recovery process shown in FIG. 10 is characterized in that, when a failure occurs in the SVOL owner node (active) in the secondary site, a command destination node is switched to a retreatment destination node (SVOL owner node (standby)) by using a communication path (retreatment path) set in advance between the PVOL owner node (active) in the primary site and the SVOL owner node (active) in the secondary site.

A process by steps S1001 to S1005 shown in the upper half of FIG. 10 is a write process that is executed before the occurrence of a node failure (when no node failure occurs). When data is written from the host to the PVOL in the primary site, the SCS 501A of the PVOL owner node calls the I/O processing program 625 to write write data to the PVOL, and then calls the data transfer process program 623 to execute the process by steps S1001 to S1005.

A process by steps S1001, S1002, and S1006 to S1014 shown in the lower half of FIG. 10 is a write process that is executed when a node failure occurs in the SVOL owner node in the secondary site, in which write process the first node failure recovery process is executed to recover from the node failure. More specifically, S1006 to S1009 are executed by the node failure recovery process program 622, and steps S1010 to S1014 are executed by the data transfer process program 623.

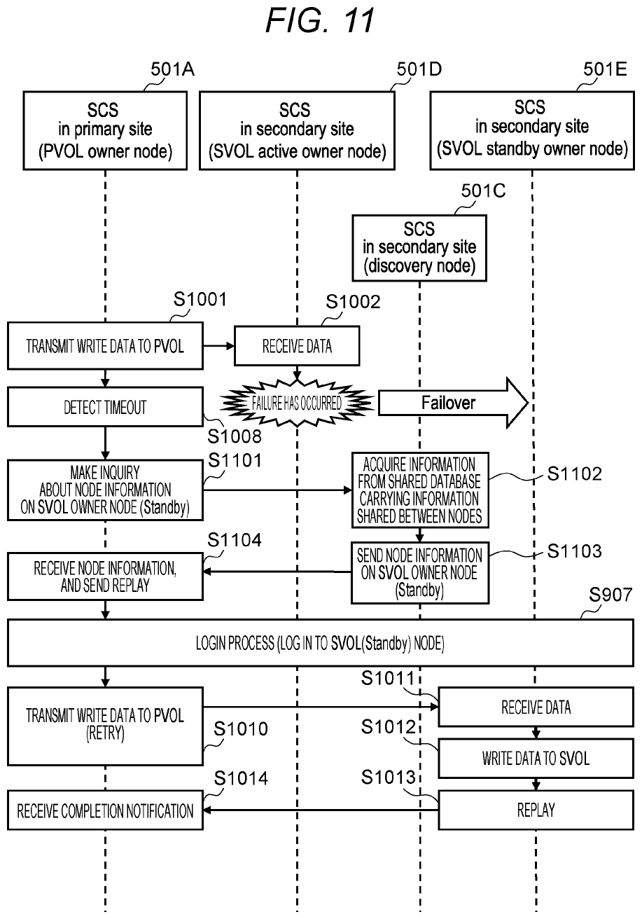

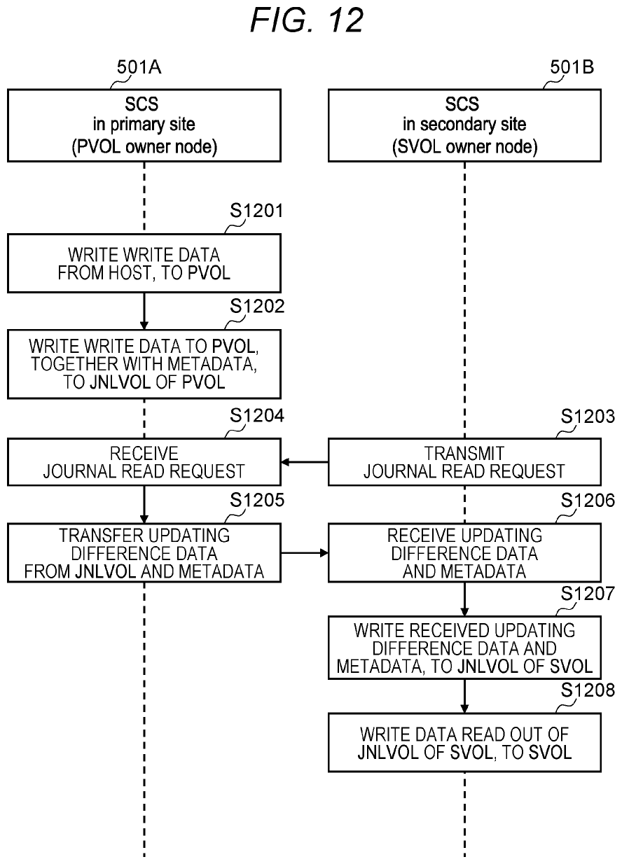

A process carried out by the data transfer process program 623, the process being shown in FIGS. 10 and 11, is a data transfer processes of directly pairing the PVOL and the SVOL and reflecting updating difference data in synchronization with I/O processing by the host. Besides such a data transfer process, the data transfer process program 623 of this embodiment may execute an asynchronous data transfer process via the journal volume. The details of the asynchronous data transfer process will be described later with reference to FIG. 12. Node failure recovery processes shown in FIGS. 10 and 11 can be combined with either one of the above data transfer processes.

According to the first node failure recovery process by the node failure recovery process program 622, a process by the SVOL is handed over to the standby node that takes over the process from the SVOL, and the primary site switches the command destination node to the standby node set in advance as a retreatment path. Through this process, even if a failure occurs at a node in the secondary site, the remote copy process can be continued.

The process (steps S1001 to S1005) that is executed before the occurrence of a node failure, the process being shown in the upper half of FIG. 10, will be described in detail.

When the PVOL owner node in the primary site receives a write request from the host, the SCS 501A of the PVOL owner node writes write data to the PVOL, after which, at step S1001, the SCS 501A transfers updating difference data to the PVOL, to the SVOL owner node (active) in the secondary site.

At step S1002, when the SVOL owner node (active) in the secondary site receives the updating difference data transferred at step S1001 from the PVOL owner node in the primary site, the SCS 501D of the SVOL owner node (active) calls the data transfer process program 623.

At step S1003, the SCS 501D writes the updating difference data received at step S1002, to the SVOL, and at step S1004, the SCS 501D sends a replay to the PVOL owner node in the primary site, the replay informing of the updating difference data having been reflected in the SVOL.

At step S1005, when the PVOL owner node in the primary site receives the replay (completion notification) made at step S1004, the SCS 501A of the PVOL owner node determines that data transfer has been completed normally, thus ending the data transfer process.

The process (steps S1001, S1002, and S1006 to S1014) to carry out at the occurrence of a node failure, the process being shown in the lower half of FIG. 10, will then be described in detail. Specifically, the procedure for the process to carry out when a failure occurs at the active SVOL owner node during data writing from the PVOL to the SVOL will be described.

Specifically, at step S1001, when the PVOL owner node in the primary site receives a write request from the host, the SCS 501A of the PVOL owner node writes write data to the PVOL, and then transfers updating difference data to the PVOL, to the SVOL owner node (active) in the secondary site. Then, at step S1002, the SVOL owner node (active) in the secondary site receives the updating difference data transferred from the PVOL owner node in the primary site. Now a case is assumed where, after the SVOL owner node (active) receives the updating difference data, a failure occurs at the SVOL owner node (active) to make communication impossible

In this case, at step S1006, the SCS 501E of the SVOL owner node (standby) associated with the SVOL owner node (active) in the secondary site, the SVOL owner node (active) having developed the failure, detects the failure of the SVOL owner node (active). The SVOL owner node (standby) detects a failure in such a way that it constantly transmits a heart beat signal to the SVOL owner node (active) and detects a failure occurring at the SVOL owner node (active) when the heart beat signal does not reach it anymore.

At step S1007, the SCS 501E executes a failover process of taking over a process from the SVOL owner node (active). By the failover process, a processing state of the owner node whose process is to be taken over, the processing state being made redundant, is loaded onto a process memory on the standby node, an execution authority for each process on the standby node is set active, and then the process is resumed. Specifically, setting the execution authority for each process active means making setting that allows the standby node to execute processes related to the ownership, storage function, and redundancy of each SVOL.

At step S1008, the SCS 501A of the PVOL owner node in the primary site fails to receive a notification of completion of reflection of the updating difference data having been transmitted at step S1001 to the SVOL in the secondary site, thus detecting timeout.

In this case, at step S1009, the SCS 501A switches the transfer destination of the updating difference data, to a retreatment path set between the PVOL owner node and the SVOL owner node (standby). In the first node failure recovery process, the retreatment path is set in advance before execution of the path creating process program 621. In other words, before the occurrence of the node failure, the PVOL owner node in the primary site has a main path set already between the PVOL owner node and the SVOL owner node (active) in the secondary site and the retreatment path set already between the PVOL owner node and the SVOL owner node (standby) in the secondary site, and at step S1009, switches the transfer destination, from the main path to the retreatment path.

Thereafter, when the PVOL owner node in the primary site receives a write request from the host, the SCS 501A, at step S1010, writes write data to the PVOL and then transfers updating difference data to the PVOL, to the SVOL owner node (standby) in the secondary site, using the retreatment path having replaced the main path at step S1009. In other words, at step S1010, the SCS 501A retries transferring the write data (updating difference data to be exact) to the PVOL.

At step S1011, the SVOL owner node (standby) in the secondary site receives the updating difference data transferred from the PVOL owner node in the primary site.

At step S1012, the SCS 501E of the SVOL owner node (standby) writes the updating difference data received at step S1011, to the SVOL.

At step S1013, the SCS 501E sends a replay to the PVOL owner node in the primary site, the replay informing of the updating difference data having been reflected in the SVOL.

At step S1014, the PVOL owner node in the primary site receives the replay (completion notification) sent at step S1013, and the SCS 501A of the PVOL owner node determines that data transfer has been completed normally, thus ending the data transfer process.

By executing the data transfer process following the node failure recovery process in the above manner, even when a node failure occurs at the SVOL owner node (active) in the secondary site, updating difference data of write data written on the PVOL can be written to the SVOL of the SVOL owner node (standby) that has been promoted from a standby node to an active node.

FIG. 11 is a sequence diagram showing an example of a procedure for a write process including a second node failure recovery process. The second node failure recovery process shown in FIG. 11 is characterized in that, when a failure occurs at the SVOL owner node (active) in the secondary site, node information on the SVOL owner node (standby) having taken over a process from the SVOL owner node (active) having developed the failure is acquired, and a communication path to the node indicated by the acquired node information (i.e., the retreatment destination node) is reset dynamically to switch a command destination node. Through this process, even if a failure occurs at a node in the secondary site, the remote copy process can be continued. The process shown in FIG. 11 includes the same process as the first node failure recovery process described in FIG. 10. The same process will not be further described and only the different process will be described.

In FIG. 11, a process to execute before step S1101 (steps S 1001, S1002, and S1008) is the same as a process to execute before step S1010 that is shown in a lower part of FIG. 10. This process is briefly described as follows. The PVOL owner node in the primary site receives a write request from the host, and the SCS 501A of the PVOL owner node calls the data transfer process program 623 to transfer updating difference data to the PVOL, to the SVOL owner node (active) in the secondary site (step S 1001). At the SVOL owner node (active) in the secondary site, the SVOL owner node (active) receiving the transferred updating difference data, the SCS 501D calls the data transfer process program 623 (step S1002). Thereafter, when a failure occurs in the SVOL owner node (active) to render its communication impossible, the SCS 501A of the PVOL owner node in the primary site detects timeout (step S1008).

In FIG. 11, steps S1101 to S1104 (or steps S1101 to S1104 plus step S907) correspond to the second node failure recovery process, and are executed by the node failure recovery process program 622. Step S907 is executed by the path creating process program 621, as described with reference to FIG. 9.

At step S1101, the SCS 501A of the PVOL owner node in the primary site makes an inquiry to the discovery node in the secondary site about node information on the SVOL owner node (standby).

At step S1102, the SCS 501C of the discovery node in the secondary site, the discovery node having received the inquiry made at step S1101, acquires the node information on the SVOL owner node (standby) from the shared database carrying information shared between nodes in the secondary site.

At step S1103, the SCS 501C sends the node information on the SVOL owner node (standby) acquired at step S1102, as a replay to the PVOL owner node in the primary site.

At step S1104, the PVOL owner node in the primary site receives the node information on the SVOL owner node (standby), as the replay from the secondary site.

Thereafter, at step S907, the SCS 501A of the PVOL owner node in the primary site calls the path creating process program 621 to establish a communication path between the PVOL owner node and the SVOL owner node (standby). The details of step S907 have been described above with reference to FIG. 9.

At completion of the process at step S907, the communication path is set, the communication path leading from the PVOL owner node in the primary site to the SVOL owner node (standby), which is the retreatment destination node. Afterward, therefore, steps S1010 to S1014 are executed in the same manner as in the case of FIG. 10. In this manner, when the second node failure recovery process is executed, the updating difference data to the PVOL can be reflected in the SVOL.

The above first and second node failure recovery processes are described as the node failure recovery processes that are carried out when a failure occurs at a node in the secondary site. However, in a case where the primary site and the secondary site are swapped in execution of the node failure recovery process, the storage system 101 can execute the same node failure recovery process as described above when a failure occurs at a node in the primary site. Swapping the primary site and the secondary site can be considered also in the path creating process described above and in a path changing process to be described later.

### (2-3) Remote Copy Process

FIG. 12 is a sequence diagram showing an example of a procedure for a remote copy process. FIG. 12 shows the remote copy process as an asynchronous data transfer process carried out via the journal volume (JNLVOL). The remote copy process shown in FIG. 12 includes a process by the I/O processing program 625 and a process by the data transfer process program 623.

According to the remote copy process carried out via the journal volume, updating difference data to the PVOL in the primary site is recorded in the journal volume, and a node having the journal volume of the SVOL in the secondary site makes an inquiry to a node having the journal volume of the PVOL in the primary site about the updating difference data, writes the acquired updating difference data to the journal volume of the SVOL, and reflects the updating difference data from the journal volume of the SVOL in the SVOL. Through data processing via the journal volume, when a plurality of PVOLs and SVOLs are registered as remote copy pairs and belong to the same consistency group, updating difference data written to the journal volume is reflected in the SVOL up to the same point of time. This allows maintaining the consistency between a plurality of SVOLs.

The remote copy process will be described in detail with reference to FIG. 12.

When the PVOL owner node in the primary site receives a write request from the host, the SCS 501A of the PVOL owner node calls the I/O processing program 625 and executes steps S1201 and S1202. At steps S1201 and S1202, which are a write process that is a part of the I/O processing program 625, write data is written to the PVOL in response to the write request from the host, and updating difference data is written to the JNLVOL.

At step S1201, the SCS 501A writes the write data from the host, to the PVOL. At step S1202, the SCS 501A writes write data to be written to the PVOL, together with metadata, to the JNLVOL of the PVOL. The metadata includes a writing time, an ID for a writing destination PVOL, a writing destination logical block address (LBA), and the transfer length of the write data.

After the data is written to the PVOL in the primary site, the SCS 501A calls the data transfer process program 623 to execute steps S1203 to S1208. Steps 1203 to 1208 may be started/executed every time the I/O processing is completed or may be executed periodically.

At step S1203, the SCS 501B of the SVOL owner node in the secondary site transmits a journal read request to the corresponding PVOL owner node in the primary site.

At step S1204, the SCS 501A of the PVOL owner node in the primary site receives the journal read request from the SVOL owner node in the secondary site. At step S1205 to follow, the SCS 501A reads updating difference data not reflected in the SVOL yet, from the journal volume, and transfers the updating differential data, together with metadata, to the SVOL owner node in the secondary site.

At step S1206, the SCS 501B receives the updating difference data and metadata transferred from the PVOL owner node in the primary site. At step S1207 to follow, the SCS 501B writes the updating difference data and metadata received at step S1206, to the journal volume of the SVOL.

Subsequently, at step S1208, the SCS 501B reads the updating difference data and metadata out of the journal volume of the SVOL and writes the updating difference data to the SVOL. When a plurality of volumes make remote copy pairs, that is, a plurality of volumes share one journal volume in each of the primary site and the secondary sites and execute the remote copy process, the SCS 501B refers to the metadata read from the journal volume in the secondary site at step S1208 and writes updating difference data up to the same point of time, to a plurality of SVOLs. Hence the remote copy process that maintains the consistency between a plurality of volumes can be achieved.

### (2-4) Path Changing Process

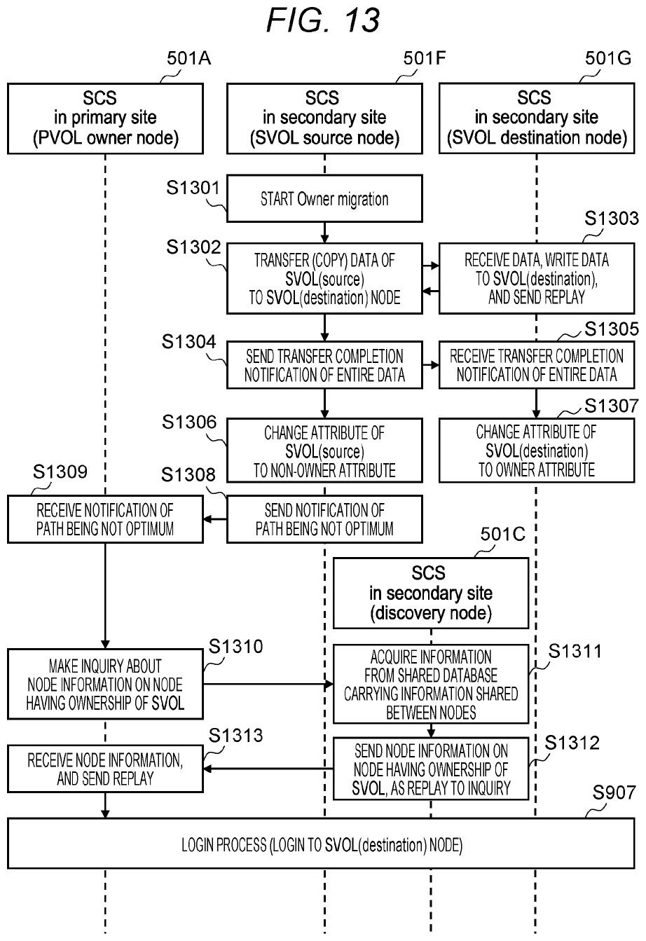

FIG. 13 is a sequence diagram showing an example of a procedure for a path changing process. When, because of an insufficient capacity of a node or a similar reason, the SVOL or the journal volume is moved to a different node in the same site (or the ownership is moved), the path changing process program 624 is called and the path changing process shown in FIG. 13 is executed.

According to the path changing process, when ownership of the SVOL is transferred from one node (SVOL source node) to another node (SVOL destination node), the storage control software (SCS) 501F of the SVOL source node notifies the primary site of the ownership having been transferred, and the storage control software (SCS) 501A of the node (PVOL owner node) having ownership of the PVOL in the primary site makes an inquiry to the secondary site about node information on the SVOL destination node and resets a communication path leading to the node indicated by the acquired node information (i.e., the SVOL destination node).

Steps S1301 to S1307 are a process of transferring the ownership of the SVOL in the secondary site, and are executed by the owner migration process program 626.

At step S1301, the SCS 501F of the SVOL owner node in the secondary site starts transfer of the ownership of the SVOL (owner migration). Transfer of the ownership is started when the performance or capacity of the node is found insufficient.

At step S1302, the SCS 501F of the SVOL node serving as the source of ownership transfer in the secondary site (SVOL source node) transfers data of the SVOL to the SVOL node serving as the destination of ownership transfer (SVOL destination node). When a write request is received from the host during data transfer, write data is written to the SVOL source node and to the SVOL destination node.

At step S1303, the SCS 501G of the SVOL destination node in the secondary site receives the data of the SVOL of the SVOL source node, from the SVOL source node and writes the data to the SVOL of the SVOL destination node.

At step S1304, when having transferred the entire data of the SVOL, the SCS 501F of the SVOL source node in the secondary site transmits a transfer completion notification of the entire data, to the SVOL destination node.

At step S1305, the SVOL destination node in the secondary site receives the transfer completion notification transmitted at step S1304.

At step S1306, the SCS 501F of the SVOL source node in the secondary site updates control information on the SVOL of the SVOL source node, to information indicating a non-owner attribute.

At step S1307, the SCS 501G of the SVOL destination node in the secondary site updates control information on the SVOL of the SVOL destination node, to information indicating an owner attribute.

Through the above process, the SVOL destination node comes to have the ownership of the SVOL, and, from that point onward, processes I/O requests from the host. When the SVOL source node having the non-owner attribute receives an I/O request from the host, the SVOL source node transfers the I/O request to the SVOL destination node, which processes the I/O request.

In a case where the cluster of the secondary site is configured by using a drive box shared between the nodes, the data transfer process of steps S1302 to S1305 may be skipped. This is because that in such a case, each node is allowed to physically access any data owned by any node and therefore transfer of the ownership can be done by merely updating the control information on the ownership at steps S1306 and S1307.

Steps S1308 to S1313 are a process of changing the communication path between the PVOL owner node in the primary site and the SVOL node in the secondary site, and are executed by the path changing process program 624.

At step S1308, the SCS 501F of the SVOL source node in the secondary site sends a notification of the current communication path being not optimum, to the PVOL owner node in the primary site. “Current communication path being not optimum” means that a communication path leading to a new SVOL owner node (SVOL destination node) is currently not set. This notification may be included in a reply to an I/O request from the host or may be transmitted not in synchronization with the reply to the I/O request. Alternately, instead of sending the notification, the communication path to the SVOL source node may be cut off to notify of the current communication path being not optimum.

At step S1309, the PVOL owner node in the primary site receives the notification of the current communication path being not optimum, from the SVOL source node.

At step S1310, the SCS 501A of the PVOL owner node in the primary site makes an inquiry to the discovery node in the secondary site about information on a node having ownership of the SVOL.

At step S1311, the SCS 501C of the discovery node in the secondary site acquires node information on the node having the ownership of the SVOL (i.e., the SVOL destination node), from the shared database carrying information shared between the nodes in the secondary site.

Then, at step S1312, the SCS 501C sends the node information acquired at step S1311, as a repay to the PVOL owner node in the primary site.

At step S1313, the PVOL owner node in the primary site receives the node information on the SVOL owner node, from the discovery node in the secondary site.

Based on the received node information, the SCS 501A of the PVOL owner node in the primary site executes the login process at step S907, thereby logging in to the SVOL destination node indicated by the node information and establishing a communication path.

After completion of the above process of step S907, the PVOL owner node in the primary site is able to communicate with the SVOL destination node for data transfer for remote copying. In this manner, when changing the SVOL owner node in the secondary site, the storage system 101 can change setting of the communication path between the PVOL owner node and the SVOL owner node, using the discovery node in the secondary site.

By executing each of the above processes, the storage system 101 according to this embodiment, when creating a remote copy pair, makes an inquiry about information on the PVOL owner node or the SVOL owner node, to the primary site or the secondary site and automatically set a communication path between the PVOL owner node and the SVOL owner node. In addition, in the storage system 101, each site records information on the ownership of the PVOL or the SVOL in the shared database 105 carrying information shared between the nodes. The primary site or the secondary site is thus able to acquire information on a node having the ownership of a volume making up a volume pair by making an inquiry to any node in the counterpart site.

Thus, according to the storage system 101 of this embodiment, when a remote copy pair is created between the primary site and the secondary site, a communication path can be automatically set between nodes having ownership of volumes to be paired. This reduces the operation cost of the storage system and prevents negative effects on the performance of the system when it executes the remote copy process.

What is claimed is:

1. A storage system comprising a primary site and a secondary site each of which includes a plurality of storage nodes and one or more drives, the storage nodes each having a processor package including a processor and a memory, wherein
storage nodes making up the primary site include a primary volume owner node having a primary volume,
storage nodes making up the secondary site include a secondary volume owner node having a secondary volume making a pair with the primary volume, and a discovery node that as a replay to an inquiry, sends node information on a node having a volume in own site,
when a communication path for remote copying from the primary volume to the secondary volume is set, a storage node in the primary site makes an inquiry to a discovery node in the secondary site about node information on a node having the secondary volume paired with the primary volume,
as a replay to the received inquiry, the discovery node sends the node information on the node having the secondary volume, and
based on the node information acquired from the discovery node, the primary volume owner node sets a communication path between the primary volume owner node and the secondary volume owner node, the communication path being used for remote copying volume data from the primary volume to the secondary volume.

2. The storage system according to claim 1, wherein
the primary volume owner node and the secondary volume owner node each include an active node that executes a process, and a standby node that takes over the process when a failure occurs at the active node,
a process of setting the communication path includes setting the communication path between the primary volume owner node as the active node and the secondary volume owner node as the active node and setting a retreatment path between the primary volume owner node as the active node and the secondary volume owner node as the standby node, and
when a failure occurs at either the primary volume owner node as the active node or the secondary volume owner node as the active node, the standby node takes over a process from the active node having developed the failure, and the communication path for the pair of volumes is switched to the retreatment path to continue processing between the pair of volumes.

3. The storage system according to claim 1, wherein
each of the primary site and the secondary site includes the discovery node,
in each of the primary site and the secondary site, a plurality of storage nodes include an active node that executes a process, and a standby node that takes over the process when a failure occurs at the active node, and wherein
when a failure occurs at either the primary volume owner node as the active node or the secondary volume owner node as the active node, the standby node takes over a process from the active node having developed the failure, the active node in a site in which the failure has not occurred makes an inquiry to the discovery node in a site in which the failure has occurred about node information on the node having taken over the process, and
based on the node information acquired from the discovery node, the primary volume owner node resets the communication path leading from the active node in the site in which the failure has not occurred to the node having taken over the process and continues processing between the pair of volumes.

4. The storage system according to claim 1, wherein when a given volume is transferred between storage nodes in one site of the primary site and the secondary site, an owner node of a volume in another site of the primary site and the secondary site, the volume making the pair with the given volume resets the communication path between the owner node and a transfer destination node of the given volume in the one site.

5. The storage system according to claim 1, wherein
when a given volume is transferred between storage nodes in one site of the primary site and the secondary site, a transfer source node of the given volume transferred sends a notification of a current communication path being not optimum, to an owner node of a volume in the other site of the primary site and the secondary site, the volume making the pair with the given volume transferred, and
the owner node of the volume in the other site, the owner node receiving the notification, makes an inquiry to a discovery node in the one site about node information on a transfer destination node having the given volume, and based on the node information acquired from the discovery node to which the inquiry has been made, resets the communication path between the owner node and the transfer destination node of the given volume.

6. The storage system according to claim 1, wherein
each of the primary site and the secondary site includes a shared database storing configuration information shared between storage nodes in each of the sites, and
when one site of the primary site and the secondary site makes an inquiry to any one of storage nodes in the other site of the primary site and the secondary site about a node having a volume in the other site, a storage node having received the inquiry acquires node information on the node about which the inquiry has been made, by referring to the shared database in the site the storage node belongs to, and sends a replay to the inquiry.

7. The storage system according to claim 1, wherein
the primary site includes a journal volume storing updating difference data of a plurality of primary volumes, together with metadata including writing time information,
at given timing, the secondary volume owner node transmits a journal read request to the primary volume owner node,
the primary volume owner node having received the journal read request transfers the updating difference data and metadata to the secondary volume owner node, referring to the journal volume in the primary site, and
the secondary volume owner node writes the updating difference data transferred from the primary volume owner node, to the corresponding secondary volume, referring to the metadata.

8. A communication path control method carried out by a storage system including a primary site and a secondary site each of which includes a plurality of storage nodes and one or more drives, the storage nodes each having a processor package including a processor and a memory, wherein
storage nodes making up the primary site include a primary volume owner node having a primary volume,
storage nodes making up the secondary site include a secondary volume owner node having a secondary volume paired with the primary volume, and a discovery node that as a replay to an inquiry, sends node information on a node having a volume in the secondary site,
when a communication path for remote copying from the primary volume to the secondary volume is set, a storage node in the primary site makes an inquiry to a discovery node in the secondary site about node information on a node having the secondary volume paired with the primary volume,
as a replay to the received inquiry, the discovery node sends the information on the node having the secondary volume, and
based on the node information acquired from the discovery node, the primary volume owner node sets a communication path between the primary volume owner node and the secondary volume owner node, the communication path being used for remote copying volume data from the primary volume to the secondary volume.
